(19) United States
(12) Patent Application Publication
(10) Pub. No.: US 2026/0039757 A1
(43) Pub. Date: Feb. 5, 2026

(54) IMAGE FORMING APPARATUS

(71) Applicant: CANON KABUSHIKI KAISHA, Tokyo (JP)

(72) Inventor: KAZUYUKI IWAMOTO, Chiba (JP)

(21) Appl. No.: 19/287,888

(22) Filed: Aug. 1, 2025

(30) Foreign Application Priority Data
Aug. 5, 2024 (JP) 2024-128946

(51) Int. Cl. H04N 1/00; B41J 3/46; B41J 13/10; B41J 29/13; G03G 15/00; G03G 15/22; G03G 21/16

(52) U.S. Cl. CPC H04N 1/00559; H04N 1/00535; H04N 1/00551; H04N 1/00631; H04N 1/00795; B41J 3/46; B41J 13/106; B41J 29/13; G03G 15/228; G03G 15/5016; G03G 15/6552; G03G 21/1633; H04N 2201/0094

(57) ABSTRACT

An image apparatus includes an image former configured to form an image on a sheet, a discharge tray with a stacking area where a sheet on which the image has been formed is to be stacked, an operation device, an image reading apparatus configured to read an image, a first support portion configured to support the image reading apparatus, and a second support portion configured to support the image reading apparatus, wherein, in a vertical direction, the image reading apparatus is supported above the discharge tray, the first support portion is arranged at one side of the discharge tray in a direction perpendicular to both the vertical direction and a discharge direction in which the sheet is discharged onto the discharge tray, the second support portion is arranged at the other side of the discharge tray.

### BACKGROUND

### Field of the Technology

The present disclosure relates to an image forming apparatus, such as a printer, a copying machine, or a multifunction apparatus.

### Description of the Related Art

An image forming apparatus includes an operation unit as a user interface. The operation unit is equipped with input interfaces, such as various key buttons and a touch panel, and output interfaces, such as a display and a speaker. The operation unit is positioned at a location easily operated from an upper part and front part of a main body of the image forming apparatus in view of user operability. The display may be equipped with a mechanism that allows an angle of its display surface to be changed. In such operation units, the display parts tend to become larger due to an increase of information displayed thereon and adaption of touch panels.

The image forming apparatus has a space including a sheet stack surface for stacking a discharged sheet on which an image is printed, and this space is provided at a location where it is easy to access it from an upper part and front part of the main body of the image forming apparatus. Considering that the operation units tend to have larger sizes as describe above, it is required that the user operability and the accessibility to the discharged sheet should be reconciled. U.S. Pat. No. 9,527,692 discloses an image forming apparatus having a configuration that realizes both operability and accessibility. In the image forming apparatus described in U.S. Pat. No. 9,527,692, an operation unit is arranged above a discharge space of a sheet, and a sheet is discharged from a back side to a front side of an apparatus main body. In a display of the operation unit, an angle of its display surface can be changed. The maximum motion space of the display of the operation unit is located above a path of a discharged sheet to a discharge space of the sheet.

Since the operation unit and a reading unit may be located around a sheet discharge tray, access to the sheets stacked on the sheet discharge tray may be affected, thereby usability also may be reduced.

### SUMMARY

An image forming apparatus according to at least one embodiment of the present disclosure includes an image former configured to form an image on a sheet, a discharge tray with a stacking area where a sheet on which the image has been formed is to be stacked, an operation device, an image reading apparatus configured to read an image, a first support portion configured to support the image reading apparatus, and a second support portion configured to support the image reading apparatus, wherein, in a vertical direction, the image reading apparatus is supported above the discharge tray, the first support portion is arranged at one side of the discharge tray in a direction perpendicular to both the vertical direction and a discharge direction in which the sheet is discharged onto the discharge tray, the second support portion is arranged at the other side of the discharge tray, an opening through which the sheet stacked on the discharge tray is to be taken out is formed by the image reading apparatus, the first support portion, the second support portion, and the discharge tray, the operation device is attached to the first support portion, and a surface that forms a portion of the opening of the second support portion is an inclined surface which inclines in a direction away from the operation device, or a curved surface which curves in a direction away from the operation device.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of an image forming apparatus.

FIG. 2 is a configuration diagram of the image forming apparatus.

FIG. 3 is a configuration diagram of the image forming apparatus.

FIG. 4 is a configuration diagram of the image forming apparatus.

FIG. 5 is a configuration diagram of the image forming apparatus.

FIG. 6 is a configuration diagram of the image forming apparatus.

FIG. 7 is a configuration diagram of the image forming apparatus.

FIG. 8 is a configuration diagram of the image forming apparatus.

FIG. 9 is a configuration diagram of a modified example of the image forming apparatus.

FIG. 10 is a configuration diagram of the modified example of the image forming apparatus.

FIG. 11 is a configuration diagram of the modified example of the image forming apparatus.

### DESCRIPTION OF THE EMBODIMENTS

Now, description is given of at least one embodiment of the present disclosure with reference to the accompanying drawings. However, the dimensions, materials, shapes, relative arrangements, etc., of components described in the following embodiments should be appropriately modified according to a configuration of an apparatus to which the present disclosure is applied and various conditions, thus, the scope of the present disclosure should not be limited to the description.

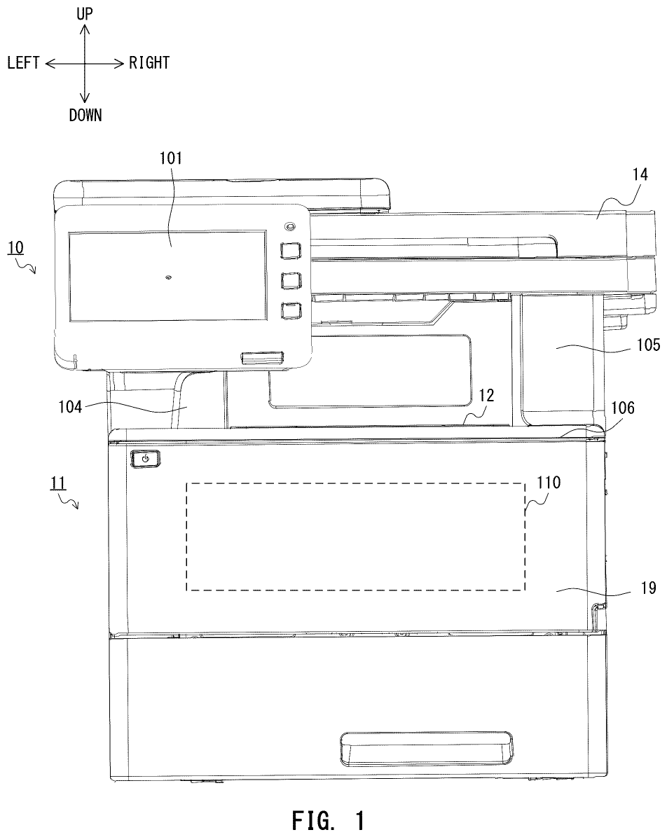

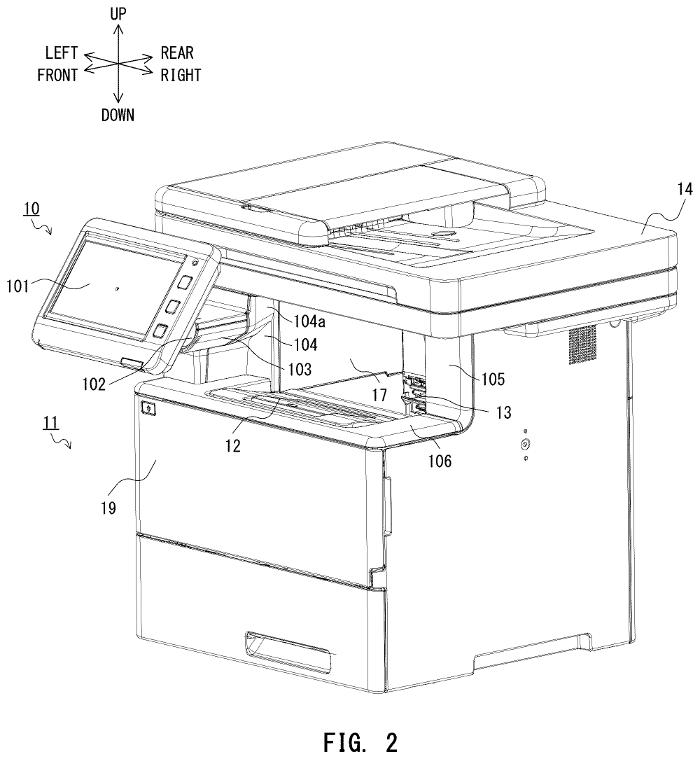

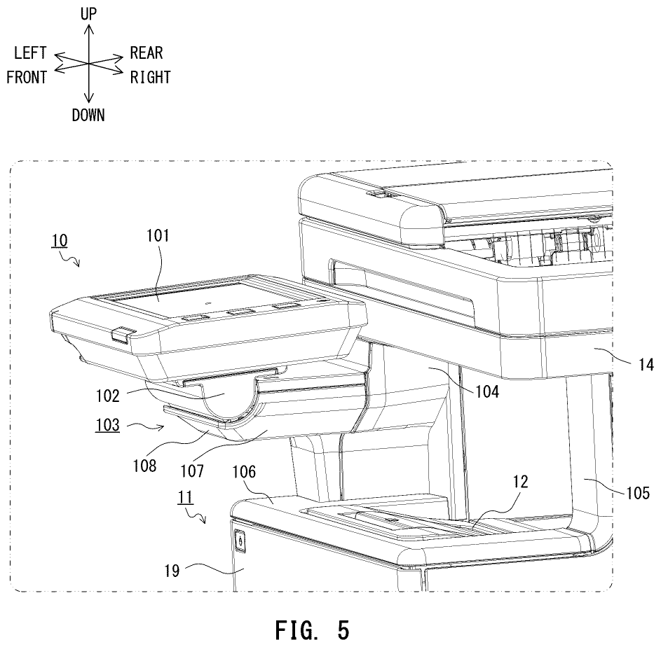

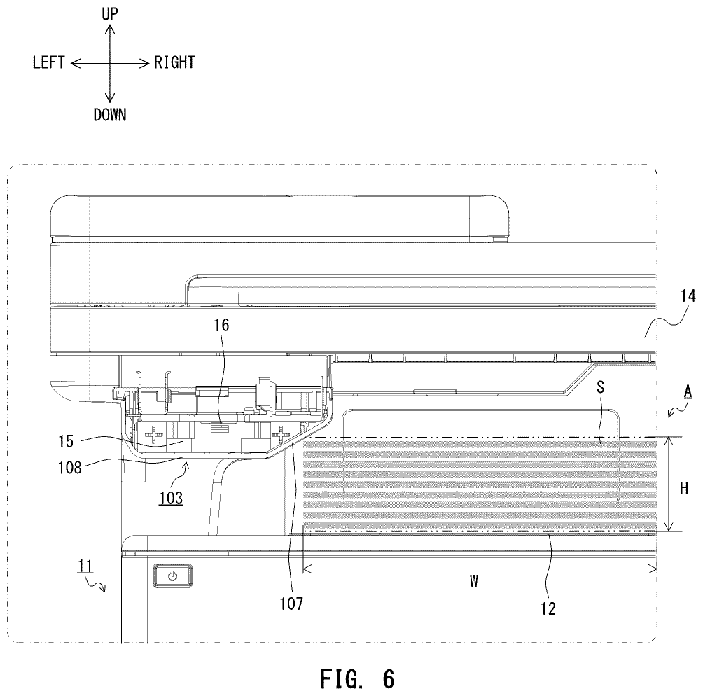

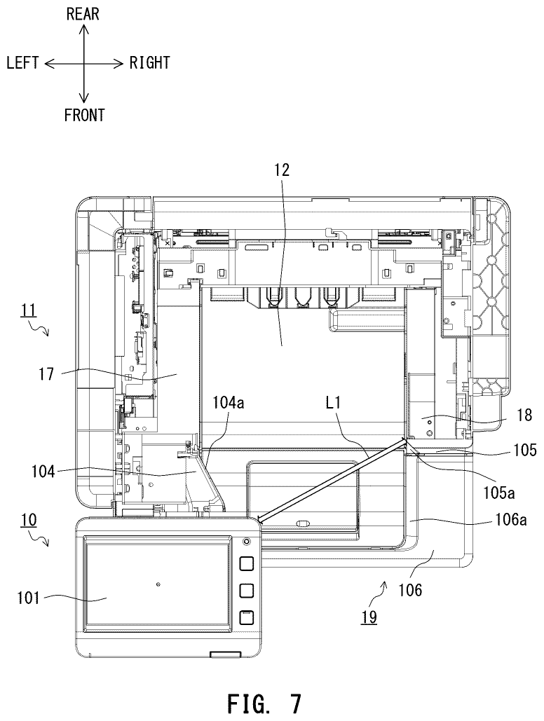

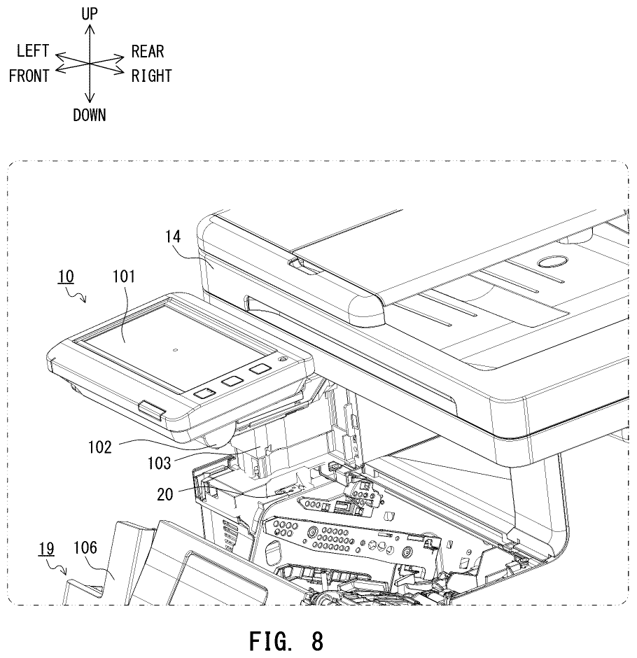

FIGS. 1-8 are configuration diagrams of an image forming apparatus according to the at least one embodiment. FIG. 1 is a front view of the image forming apparatus. FIGS. 2-4 are perspective views of the image forming apparatus as viewed from various directions. FIG. 5 is an expansion perspective view of an operation unit portion. FIG. 6 is a cross-sectional view of the image forming apparatus as viewed from the front. FIG. 7 is a top view of a main body of the image forming apparatus as viewed from the top in the vertical direction. FIG. 8 is an enlarged perspective view of the operation unit portion.

The image forming apparatus includes an image forming unit 110, which serves as an image former, to form an image on a sheet inside an apparatus main body 11. The image forming apparatus has an operation unit 10, which serves as an operation device, attached to an upper front side of the apparatus main body 11. The operation unit 10 is a user interface that includes input interfaces, such as various key buttons and a touch panel, and an output interfaces, such as a display 101 and a speaker. An image reading apparatus 14 to read images from a document is located at an upper portion of the apparatus main body 11. The apparatus main body 11 includes a discharge tray 12, a discharge portion 13, a main body first frame 17, a main body second frame 18, an opening/closing cover unit 19, and a board support plate 20. The image forming apparatus comprises an operation unit support portion cover 103 (hereinafter referred to as “support cover 103”), a main body first frame cover 104 (hereinafter referred to as “first frame cover 104”), a main body second frame cover 105 (hereinafter referred to as “second frame cover 105”), and an opening/closing cover 106.

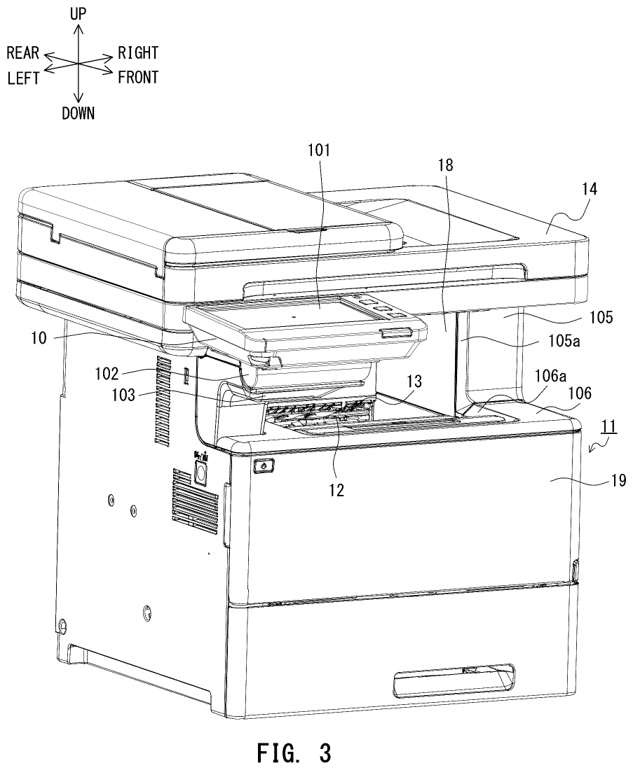

As shown in FIGS. 2 and 3, the sheet S on which an image has been printed by the image forming apparatus is discharged from the discharge portion 13 toward the front from the rear of the apparatus main body 11. The discharged sheet S is stacked on a sheet stacking surface of the discharge tray 12. The discharge tray 12 is provided in a discharge space between the upper end of the apparatus main body 11 and the image reading apparatus 14.

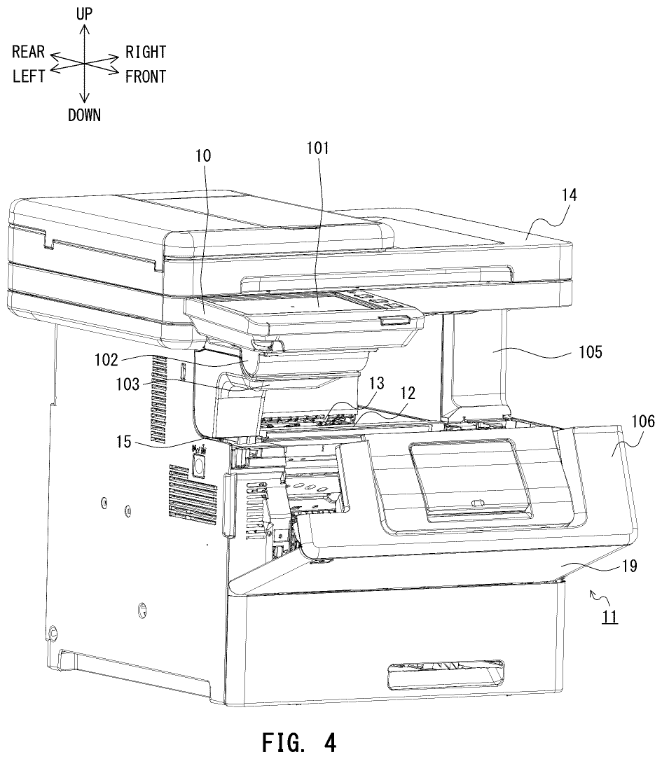

As shown in FIG. 4, the opening/closing cover unit 19 is mounted so as to be openable and closable relative to the apparatus main body 11 at a position at the upper end and front side of the apparatus main body 11. The opening/closing cover unit 19 is provided to allow access to internal units of the apparatus main body 11. Note that the opening/closing cover 106 is attached to the opening/closing cover unit 19.

As illustrated in FIGS. 5 and 6, the operation unit 10, which serves as an operation device, is arranged at a position above the apparatus main body 11 and also front side of the image reading apparatus 14. The operation unit 10 is supported, in an up-down direction, by an operation unit support portion 15 and an operation unit support plate 16. The support cover 103 is attached to the operation unit support portion 15. The operation unit 10 includes an operation unit hinge 102. The operation unit 10 is rotatable by the operation unit hinge 102, and a display surface of the display 101 can be adjusted to a predetermined angle. The movable range of the operation unit 10 is at least from an angle at which the display surface of the display 101 faces forward as shown in FIG. 1 to an angle at which it faces upward as shown in FIG. 3.

As shown in FIG. 6 and FIG. 1, when viewed from above in the vertical direction, a portion of the support cover 103 and the display 101 are arranged to overlap with the discharge tray 12 in a left-right direction of the apparatus main body 11. Hereinafter, the length in the up-down direction between the sheet stacking surface of the discharge tray 12 and a lower end of the support cover 103 is described as “maximum sheet stacking height H”. Sheets discharged onto the sheet stacking surface may curl. For this reason, the maximum sheet stacking height H is defined as a sum of a height of the sheets when the maximum number of sheets are stacked on the discharge tray 12 and the maximum curl height of the discharged sheet. The maximum curl height of the discharged sheet is the maximum value of the curl of the sheet, which is generated when the sheet is discharged onto the discharge tray 12, in the up-down direction, and varies depending on conditions such as the type of the sheet, temperature, and humidity. Thus, in the at least one embodiment, it is desirable to optimize sheet conveyance settings and image forming settings for each product so that the maximum curl height of the discharged sheet satisfies curl height specifications defined for each product.

Hereinafter, the maximum sheet size stacked on the sheet stacking surface of the discharge tray 12 is defined as “maximum sheet stacking width W”. Further, the area enclosed by the maximum sheet stacking height H and the maximum sheet stacking width W, i.e., discharge space, is defined as the maximum sheet stacking area A. As described above, since the operation unit 10 is arranged at a position above (and also front of the image reading apparatus 14) the apparatus main body 11, accessibility to the sheets discharged onto the maximum sheet stacking area A is reduced. Further, it is difficult to miniaturize the entire image forming apparatus since the operation unit 10 is arranged above the apparatus main body 11 to prevent the operation unit 10 from interfering with a path of the sheet when discharged onto the sheet stacking surface.

As shown in FIG. 6, the support cover 103 has an inclined surface 107 at the lower end portion protruding in the horizontal direction toward the maximum sheet stacking area A. The inclined surface 107 serves as a sheet discharge guide and improves sheet stacking performance. The support cover 103 is formed so that a portion of the inclined surface 107 is located above the maximum sheet stacking area A.

As shown in FIG. 7, the main body first frame 17 and the main body second frame 18 are positioned at the upper portion of the apparatus main body 11. The image reading apparatus 14 is supported at the upper portion in the vertical direction of the apparatus main body 11 by the main body first frame 17 and the main body second frame 18. The image reading apparatus 14 is also supported by the operation unit support portion 15 and the operation unit support plate 16. The operation unit support portion 15, the operation unit support plate 16, and the main body first frame 17 are support members which support the image reading apparatus 14 at the left side of the discharge tray 12. The main body second frame 18 is a support member which supports the image reading apparatus 14 at the right side of the discharge tray 12. The first frame cover 104 is attached to the main body first frame 17, and the second frame cover 105 is attached to the main body second frame 18. In this configuration, the image reading apparatus 14 is supported above the discharge tray 12 in the vertical direction.

As shown in FIG. 7, FIG. 2, and FIG. 3, the image reading apparatus 14, the first frame cover 104, the second frame cover 105, and the opening/closing cover 106 form an opening for taking out the sheet S discharged onto the discharge tray 12. The first frame cover 104, the second frame cover 105, and the opening/closing cover 106 are provided with inclined surfaces on surfaces that form a part of the opening to improve accessibility to the sheet S discharged onto the discharge tray 12. As shown in FIG. 8, the board support plate 20 is disposed at a position at the upper end and also the left end of the apparatus main body 11, and is fixedly mounted to the apparatus main body 11.

The first frame cover 104 and the second frame cover 105 are arranged in the horizontal direction, which is perpendicular to both the vertical direction and a discharge direction (i.e., a direction from the rear to the front of the apparatus main body 11) in which the sheet S is discharged from the discharge portion 13 to the discharge tray 12, with the maximum sheet stacking area A in between. The first frame cover 104 is arranged at the one side of the discharge tray 12. The second frame cover 105 is arranged at the other side of the discharge tray 12. The operation unit 10 is attached to the first frame cover 104. The first frame cover 104 is attached to the first frame 17 to serve as a support member for supporting the image reading apparatus 14. The second frame cover 105 is attached to the second frame 18 to serve as a support member for supporting the image reading apparatus 14. The opening/closing cover 106 is provided on a lower side of an opening portion.

### <Operation Unit Support Portion Cover>

As shown in FIG. 2, the sheet S on which an image is printed is discharged from the rear to the front of the apparatus main body 11 by the discharge portion 13 and is stacked on the discharge tray 12. As illustrated in FIG. 5, the operation unit 10 is arranged at a position above the apparatus main body and also front of the image reading apparatus 14. The operation unit 10 is supported by the operation unit support portion 15 and the operation unit support plate 16 (see FIG. 6).

As shown in FIG. 6 and FIG. 1, the display 101 of the operation unit 10 and a portion of the support cover 103 are arranged to overlap with the discharge tray 12 in the horizontal direction. The support cover 103 has an inclined surface 107, at the lower end portion protruding toward the maximum sheet stacking area A, to serve as a sheet conveyance guide. The inclined surface 107 is provided above the maximum sheet stacking area A. With this configuration, the support cover 103 does not interfere with the path of the discharged sheet S and does not affect the sheet stacking performance.

The inclined surface 107 of the support cover 103 is explained.

As shown in FIG. 6, the support cover 103 is provided such that a part (right side portion) overlaps with the maximum sheet stacking area A in the horizontal direction, and the other part (left side portion) excluding the part is provided in an area outside the maximum sheet stacking area A. The inclined surface 107 is provided on a side of a portion of the support cover 103 which overlaps with the maximum sheet stacking area A. The other portion of the support cover 103 is a lower portion 108 which is parallel to the sheet stacking surface of the discharge tray 12. The support cover 103 is configured such that a length in the up-down direction at a side of the inclined surface 107 is shorter than a length in the up-down direction at a side of the lower portion 108. The inclined surface 107 is inclined so that the length in the up-down direction between the inclined surface 107 and the sheet stacking surface becomes shorter as it approaches the side of the maximum sheet stacking area A, i.e., toward the tip thereof. The lower portion 108 has a flat surface shape on the side facing the sheet stacking surface and is configured so that the length in the left-right direction is longer than half the horizontal length of the support cover 103.

In this way, in a case where a part of the support cover 103 and the display 101 of the operation unit 10 overlap, in the horizontal direction, with the discharge tray 12, an inclined surface 107 is positioned at the overlapping portion. This suppresses deterioration of the sheet stacking performance of the discharged sheet S. In addition, the inclined surface 107 serves as a conveyance guide for the sheet S to be discharged. With this configuration, it is possible to arrange the operation unit 10 lower than the path of the discharged sheet S. Thus, it is not necessary to make the operation unit 10 and the support cover 103 to be large in the upper portion of the apparatus main body 11. In addition, it is possible to minimize the size in the up-down direction from the lower end of the apparatus main body 11 to the upper end of the operation unit 10 or the image reading apparatus 14.

The image reading apparatus 14 provided in the image forming apparatus is an optional device and may not be installed. In an image forming apparatus that is not equipped with the image reading apparatus 14 may not have the main body first frame 17 and the main body second frame 18 in the apparatus main body 11. The operation unit 10 is disposed above the apparatus main body 11 and is supported, as to the up-down direction of the apparatus main body 11, by the operation unit support portion 15 and the operation unit support plate 16. The inclined surface 107 of the support cover 103 is described as above.

In the at least one embodiment, the path of the discharged sheet is protected by the inclined surface 107, however, the shape of the support cover 103 is not limited to this. For example, the support cover 103 may be formed, instead of the inclined surface 107, in a crank shape for avoiding interference with the maximum sheet stacking area A. Even when the inclined surface 107 is formed in the crank shape instead of the inclined surface, the path of the sheet during discharge is ensured. Thus, it is not necessary to make the operation unit 10 and the support cover 103 to be large in the upper portion of the apparatus main body 11. In addition, it is possible to minimize the size in the up-down direction from the lower end of the apparatus main body 11 to the upper end of the operation unit 10 or the image reading apparatus 14.

### <Accessibility to Sheet Stacked on Discharge Tray>

As describe above, the first frame cover 104, the second frame cover 105, and the opening/closing cover 106 are provided with inclined surfaces, at portions facing the discharge tray 12, to improve accessibility to the sheet S discharged onto the discharge tray 12. These covers form an opening through which the sheet in the discharge tray 12 is taken out, and are provided around the opening portion. In each of the covers, the inclined surface is provided at the opening portion through which the sheet S in the discharge tray 12. The operation unit 10 protrudes into the maximum sheet stacking area A. Thus, the operation unit 10 is arranged such that a portion of the same covers the opening portion, as shown in FIG. 1.

Specifically, the second frame cover 105 has an inclined surface 105a which inclines in a direction away from the operation unit 10 on a surface that forms a part of the opening portion. The opening/closing cover 106 has an inclined surface 106a which inclines away (downward) from the operation unit 10 on a surface that forms a part of the opening portion. By providing the inclined surfaces 105a and 106a, the visibility of the sheet S stacked on the discharge tray 12 is improved, and the user can easily remove the sheet S from a right side of the main body, avoiding the operation unit 10.

The first frame cover 104 has, on a surface that forms a part of the opening portion, an inclined surface 104a which inclines in the same direction as the inclined surface 105a of the second frame cover 105. By providing the inclined surface 104a, in a case where the sheet S is taken out, the sheet S is less likely to collide with the operation unit 10, and a direction of taking out the sheet S is guided toward the right side of the main body. In addition, a length L1 of an arrow shown in FIG. 7 is the maximum width direction length in a case where the sheet S is taken out. The maximum width direction length is longer than a width direction length of 216 mm of the maximum sheet size LGL which can be used in the image forming apparatus. Therefore, the user can smoothly take out the sheet S from the right side of the main body, regardless of the sheet size and avoiding the operation unit 10.

The inclined surface 105a provided to the second frame cover 105 is provided at a rear side of a front surface side of the image reading apparatus 14. Thus, the visibility of the sheet stacked on discharge tray 12 is improved. Further, the Sheet S can be smoothly taken out from the right side of the main body, avoiding the operation unit 10 and the image reading apparatus 14.

As described above, the visibility of the sheet S stacked on the discharge tray 12 is improved by providing, to the second frame cover 105, the inclined surface 105a which inclines in a direction away from the operation unit 10. Further, the Sheet S can be smoothly taken out from the right side of the main body, avoiding the operation unit 10. The visibility of the sheet S stacked on the discharge tray 12 is improved by providing, to the opening/closing cover 106, the inclined surface 106a which inclines in a direction away from the operation unit 10. Further, the Sheet S can be smoothly taken out from the right side of the main body, avoiding the operation unit 10. The first frame cover 104 is equipped with the inclined surface 104a which inclines in a direction following the inclined surface 105a of the second frame cover 105. Thus, in a case where the sheet S is taken out, the sheet S is less likely to collide with the operation unit 10, and the direction of taking out the sheet S is guided toward the right side of the main body.

Since the length L1 between the operation unit 10 and the inclined surface 105a of the second frame cover 105 is equal to or longer than the sheet width of the sheet having a maximum size, the sheet S can be smoothly taken out from the right side of the main body by avoiding the operation unit 10 for all sheet sizes. The inclined surface 105a provided to the second frame cover 105 is provided at a rear side of a front surface side of the image reading apparatus 14. Thus, the visibility of the sheet S stacked on the discharge tray 12 is improved. Further, the Sheet S can be smoothly taken out from the right side of the main body, avoiding the operation unit 10 and the image reading apparatus 14.

With this configuration, even an image forming apparatus equipped with the image reading apparatus 14 at the top can be provided with the operation unit 10 having the display 101 of a large size without increasing the overall size. Further, the visibility and the accessibility of the sheet S, on which an image has been printed and stacked on the discharge tray 12, is ensured, thus the usability is improved.

### Modification Example

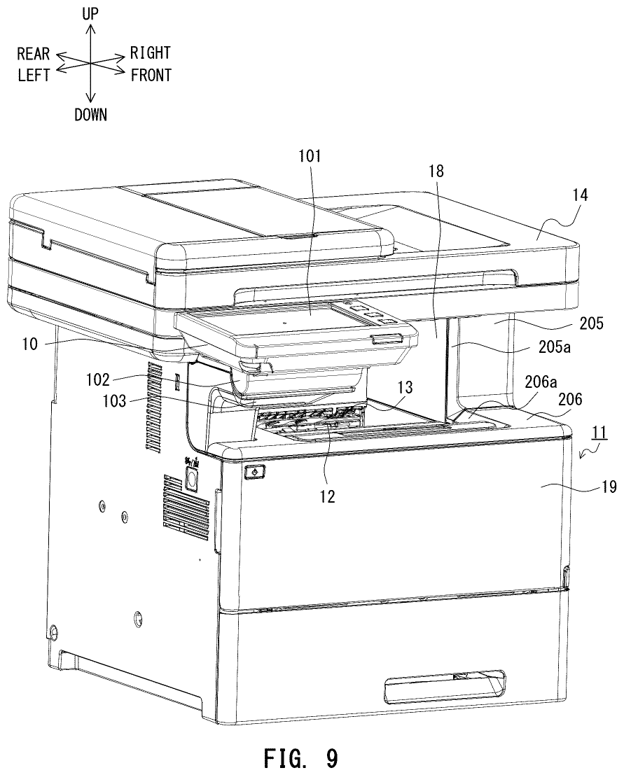

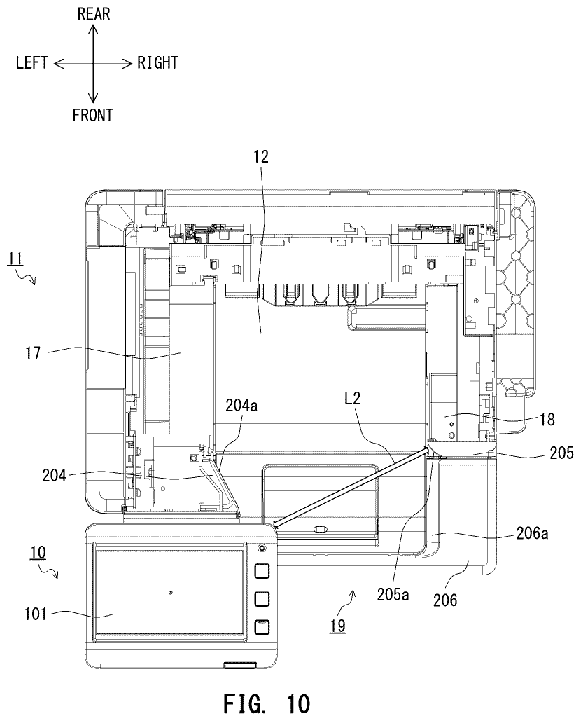

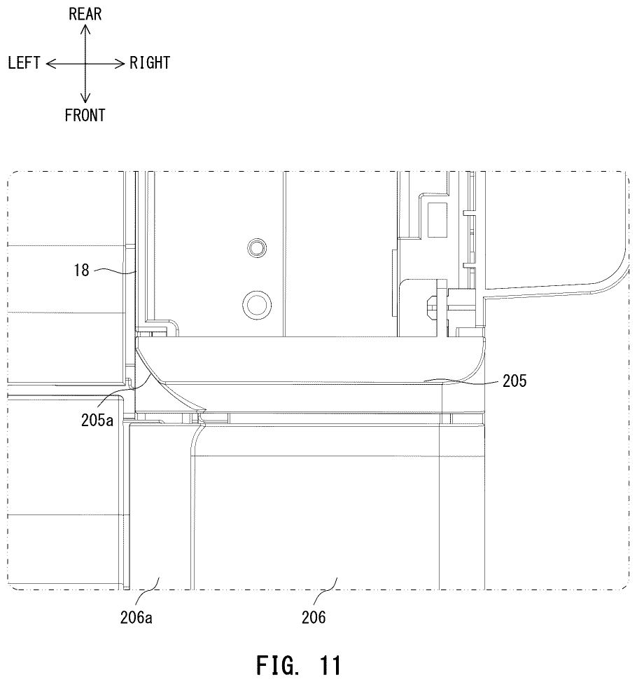

FIGS. 9-11 are configuration diagram of modified examples of the image forming apparatus. FIG. 9 is a perspective view of the image forming apparatus. FIG. 10 is a top view of the main body of the image forming apparatus. FIG. 11 is an enlarged view of the second frame cover of a body and an opening/closing cover.

Differences between the image forming apparatus of FIGS. 1 to 8 and the image forming apparatus of FIGS. 9-11 are described. A main body first frame cover 204 (hereinafter referred to as “first frame cover 204”), a main body second frame cover 205 (hereinafter referred to as “second frame cover 205”), and an opening/closing cover 206 of the image forming apparatus of FIGS. 9-11 differ from the corresponding covers of the image forming apparatus of FIGS. 1-8. The first frame cover 204, the second frame cover 205, and the opening/closing cover 206 are provided with curved surface portions to improve accessibility to the sheet S discharged onto the discharge tray 12. These covers are provided around the opening portion through which the sheet in the discharge tray 12 is taken out. In each of the covers, the curved surface portion is provided at a portion of the opening through which the sheet S in the discharge tray 12. The operation unit 10 protrudes into the maximum sheet stacking area A. Thus, the operation unit 10 is arranged such that a portion of the same covers the opening portion, as shown in FIG. 1.

Specifically, the second frame cover 205 has, on a surface that forms a part of the opening portion, a curved surface portion 205a which curves in a direction away from the operation unit 10. The opening/closing cover 206 has a curved surface portion 206a which curves away (downward) from the operation unit 10 on a surface that forms a part of the opening portion. By providing the curved surface portions 205a and 206a, the visibility of the sheet S stacked on the discharge tray 12 is improved, and the user can easily remove the sheet S from a right side of the main body, avoiding the operation unit 10.

The first frame cover 204 has, on a surface that forms a part of the opening portion, a curved surface portion 204a which curves in the same direction as the curved surface portion 205a of the second frame cover 205. By providing the curved surface portion 204a, in a case where the sheet S is taken out, the sheet S is less likely to collide with the operation unit 10, and a direction of taking out the sheet S can be guided toward the right side of the main body. In addition, a length L2 of an arrow shown in FIG. 10 is the maximum width direction length in a case where the sheet S is taken out. The maximum width direction length is longer than a width direction length of 216 mm of the maximum sheet size LGL which can be used in the image forming apparatus. Therefore, the user can smoothly take out the sheet S from the right side of the main body, regardless of the sheet size and avoiding the operation unit 10.

The curved surface portion 205a provided to the second frame cover 205 is provided at a rear side of a front surface side of the image reading apparatus 14. Thus, the visibility of the sheet stacked on discharge tray 12 is improved. Further, the Sheet S can be smoothly taken out from the right side of the main body, avoiding the operation unit 10 and the image reading apparatus 14.

As described above, the visibility of the sheet S stacked on the discharge tray 12 is improved by providing, to the second frame cover 205, the curved surface portion 205a which curves in a direction away from the operation unit 10. Further, the Sheet S can be smoothly taken out from the right side of the main body, avoiding the operation unit 10. The visibility of the sheet S stacked on the discharge tray 12 is improved by providing, to the opening/closing cover 206, the curved surface portion 206a which curves in a direction away from the operation unit 10. Further, the Sheet S can be smoothly taken out from the right side of the main body, avoiding the operation unit 10. The first frame cover 204 is equipped with the curved surface portion 204a which curves in a direction following the curved surface portion 205a of the second frame cover 205. Thus, in a case where the sheet S is taken out, the sheet S is less likely to collide with the operation unit 10, and the direction of taking out the sheet S is guided toward the right side of the main body.

Since the length L2 between the operation unit 10 and the curved surface portion 205a of the second frame cover 205 is equal to or longer than the sheet width of the sheet having a maximum size, the sheet S can be smoothly taken out from the right side of the main body by avoiding the operation unit 10 for all sheet sizes. The curved surface portion 205a provided to the second frame cover 205 is provided at a rear side of a front surface side of the image reading apparatus 14. Thus, the visibility of the sheet S stacked on the discharge tray 12 is improved. Further, the Sheet S can be smoothly taken out from the right side of the main body, avoiding the operation unit 10 and the image reading apparatus 14.

With this configuration, even an image forming apparatus equipped with the image reading apparatus 14 at the top can be provided with the operation unit 10 having the display 101 of a large size without increasing the overall size. Further, the visibility and the accessibility of the sheet S, on which an image has been printed and stacked on the discharge tray 12, is ensured, thus the usability is improved.

As described above, in the image forming apparatus of the at least one embodiment, the covers are provided around the opening portion through which the sheet S in the discharge tray 12 is taken out. Further, in each cover, a surface that form the opening portion is chamfered to form an inclined surface or a curved surface portion. In each cover, an inclined surface which inclines in a direction away from the operation unit 10 or a curved surface that curves in a direction away from the operation unit 10 is formed. This makes it easy to see and remove the sheet S while avoiding the operation unit 10. Further, according to the at least one embodiment, there is provided an image forming apparatus in which the reduction of the usability is suppressed.

According to the at least one embodiment, decrease in the usability can be suppressed.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-128946, filed Aug. 5, 2024, which is hereby incorporated by reference herein in its entirety.

What is claimed is:

1. An image forming apparatus, comprising:
an image former configured to form an image on a sheet;
a discharge tray with a stacking area where the sheet on which the image has been formed is to be stacked;
an operation device;
an image reading apparatus configured to read an image;
a first support portion configured to support the image reading apparatus; and
a second support portion configured to support the image reading apparatus, wherein:
in a vertical direction, the image reading apparatus is supported above the discharge tray;
the first support portion is arranged at one side of the discharge tray in a direction perpendicular to both the vertical direction and a discharge direction in which the sheet is discharged onto the discharge tray;
the second support portion is arranged at the other side of the discharge tray;
an opening through which the sheet stacked on the discharge tray is to be taken out is formed by the image reading apparatus, the first support portion, the second support portion, and the discharge tray;
the operation device is attached to the first support portion; and
a surface that forms a portion of the opening of the second support portion is an inclined surface which inclines in a direction away from the operation device, or a curved surface which curves in a direction away from the operation device.

2. The image forming apparatus according to claim 1, further comprising a cover provided on a lower side of the opening and having an inclined surface which inclines downward.

3. The image forming apparatus according to claim 1,
wherein the operation device is arranged such that a portion of the operation device covers the opening, and
wherein the second support portion comprises the inclined surface on a surface that forms a portion of the opening and arranged furthest from the operation device.

4. The image forming apparatus according to claim 3,
wherein the image reading apparatus is configured to read an image from a document and provided at an upper portion of the stacking area, and
wherein the inclined surface of the second support portion is provided at a rear side of a front surface side of the image reading apparatus.

5. The image forming apparatus according to claim 3,
wherein a length between the second support portion and the operation device is equal to or longer than a sheet width of a maximum size sheet to be discharged by the discharge tray.

6. The image forming apparatus according to claim 1,
wherein the operation device is arranged such that a portion of the operation device covers the opening, and
wherein the first support portion comprises the inclined surface which inclines in a same direction as the inclined surface of the second support portion on a surface that forms a portion of the opening and is covered by the operation device.

7. The image forming apparatus according to claim 1, further comprising a cover provided on a lower side of the opening and having an inclined surface which inclines downward,
wherein the operation device is arranged such that a portion of the operation device covers the opening,
wherein the second support portion comprises the inclined surface on a surface that is a part of the opening and arranged furthest from the operation device, and
wherein the first support portion comprises the inclined surface which inclines in a same direction as the inclined surface of the second support portion on a surface that forms a portion of the opening and is covered by the operation device.

8. The image forming apparatus according to claim 1, further comprising,
a cover provided on a lower side of the opening and having a curved surface which curves downward.

9. The image forming apparatus according to claim 1,
wherein the operation device is arranged such that a portion of the operation device covers the opening, and
wherein the second support portion comprises the curved surface on a surface that forms a portion of the opening and is arranged furthest from the operation device.

10. The image forming apparatus according to claim 9,
wherein the image reading apparatus is configured to read an image from a document and provided at an upper portion of the stacking area, and
wherein the curved surface of the second support portion is provided at a rear side of a front surface side of the image reading apparatus.

11. The image forming apparatus according to claim 9,
wherein a length between the second support portion and the operation device is equal to or longer than a sheet width of a maximum size sheet to be discharged by the discharge tray.

12. The image forming apparatus according to claim 1,
wherein the operation device is arranged such that a portion of the operation device covers the opening,
wherein the first support portion comprises the curved surface which curves in a same direction as the curved surface of the second support portion on a surface that forms a portion of the opening and is covered by the operation device.

13. The image forming apparatus according to claim 1, further comprising a cover provided on a lower side of the opening and having a curved surface which curves downward,
wherein the operation device is arranged such that a portion of the operation device covers the opening,
wherein the second support portion comprises the curved surface on a surface that is a part of the opening and arranged furthest from the operation device,
wherein the first support portion comprises the curved surface which curves in a same direction as the curved surface of the second support portion on a surface that forms a portion of the opening and is covered by the operation device.
